(19) United States
(12) Patent Application Publication
(10) Pub. No.: US 2010/0101128 A1
(43) Pub. Date: Apr. 29, 2010

(54) Ballcap Banner

(76) Inventor: Mark Anthony Landolfi, Hanover, MA (US)

Correspondence Address: Mark A Landolfi, 285 Old Town Way, Hanover, MA, 02339, US

(21) Appl. No.: 12/603,597

(22) Filed: Oct. 22, 2009

Related U.S. Application Data
(60) Provisional application No. 61/197,114, filed on Oct. 23, 2008.

(51) Int. Cl. G09F 17/00; B65D 85/18

(52) U.S. Cl. 40/604

(57) ABSTRACT

The ballcap banner is a team flag or banner that integrates 7″×5″ pockets for the storage of baseball caps. Only the ballcap banner evolves a team flag/banner into a multi-pocketed storage device allowing users to display their team pride while conveniently storing their baseball caps. Grommets at the four corners allow the user to hang the banner on the back of a door or on a wall.

### CROSS-REFERENCE/RELATED APPLICATIONS

Provisional patent# is 61/197,114 (Ballcap Banner)

### BACKGROUND OF THE INVENTION

The idea for Ballcap Banners was born in a UCONN dorm room in the late 1980s by Mark Landolfi, a UCONN football player who owned too many baseball caps and had nowhere to store them. He took his UCONN Huskies banner to a local silkscreener and had pockets sewn in to illustrate his idea. Life took over and the banner lived in a box in the trunk of his car . . . until 2008 when he felt he had the resources around him to bring his product to market.

### BRIEF DESCRIPTION OF THE INVENTION

Ballcap banners are a unique method of storing and displaying baseball caps. The banner is constructed from 2-ply nylon, a silk-screened team logo in the center and pockets along the top and bottom border. The pockets snugly fit the bill of standard size baseball caps—protecting the shape and structure of the crown. The banner can be displayed on a wall or on the back of a standard size interior door via grommets located at the four corners.

Only the ballcap banner marries a team banner with pockets for the purpose of storing baseball caps and allows users to proudly display their team spirit while conveniently storing their baseball caps.

### DETAILED DESCRIPTION OF THE INVENTION

The Ballcap Banner is a team flag or banner that incorporates 7″×5″ pockets for baseball cap storage. For example, a ballcap banner would be constructed of 2-ply nylon with dimensions of 2.5′×4′ that includes four 7″×5″ pockets sewn along the top and four 7″×5″ pockets bottom border for baseball cap storage. The team logo is applied in the center. The pockets snugly hold the bill of standard size baseball caps protecting the shape and structure of the crown. The banner can be displayed on the back of a door or on a wall via the 4 circular grommets located at each corner.

The ballcap banner can be various sizes. The number of storage pockets varies based on the desired overall dimensions of the banner. The banner can be constructed from nylon, wool, or any other standard flag/banner material. The logo can be applied via any standard appliqué method: embroidery, silk-screen, hand-sew, etc.

### BRIEF DESCRIPTION OF THE DRAWINGS

FIG. 1: View of the ballcap banner from the front

FIG. 2: View of the ballcap banner from the back

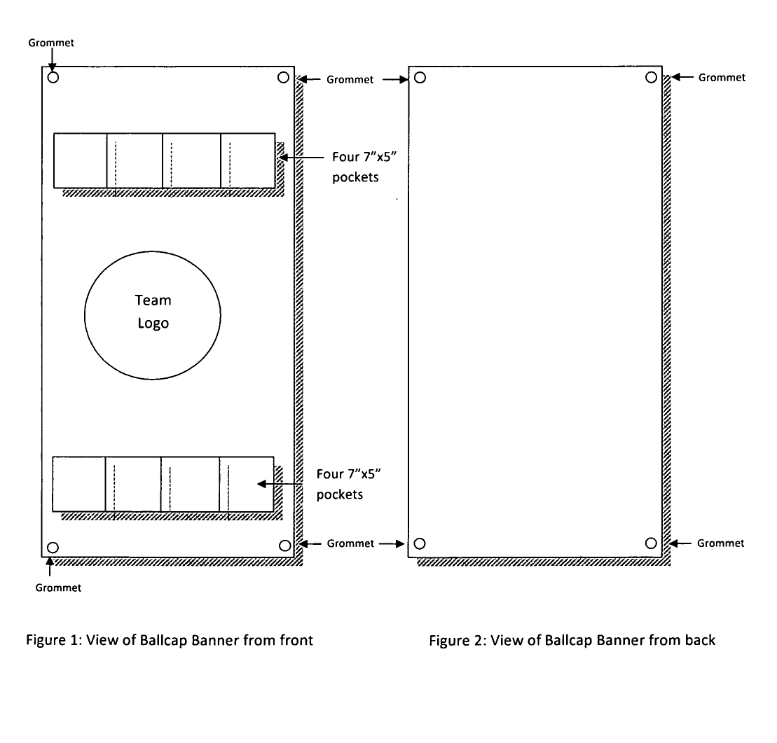

1. I claim the idea of integrating two existing items 1. the team flag or banner, and 2. the multi-pocketed storage device that hangs on a door or wall into one device for the purpose of storing baseball caps.
